(19) United States
(12) Patent Application Publication
(10) Pub. No.: US 2009/0193804 A1
(43) Pub. Date: Aug. 6, 2009

(54) Heat exchanger and stirling engine

(76) Inventors: Hirotaka Ohno, Nara (JP); Haruyoshi Noda, Nara (JP)

Correspondence Address: BIRCH STEWART KOLASCH & BIRCH, PO BOX 747, FALLS CHURCH, VA, 22040-0747, US

(21) Appl. No.: 11/630,692

(22) PCT Filed: May 13, 2005
(86) PCT No.: PCT/JP05/08757

§ 371 Date: Dec. 27, 2006

(30) Foreign Application Priority Data
Jul. 6, 2004 (JP) 2004-198807

(51) Int. Cl. F02G 1/055; F28F 1/10

(52) U.S. Cl. 60/516; 165/181

(57) ABSTRACT

A heat exchanger includes: a cylindrical member made of metal as an outer shell body; a corrugated fin that is made of metal and that is attached to the cylindrical member as a heat exchanging member; and a coating layer formed on at least one of a surface of the cylindrical member and a surface of the corrugated fin. The corrugated fin is pressure-contacted to the cylindrical member. The heat exchanger can be provided, for example, to a heat absorbing portion or a heat dissipating portion of a Stirling engine.

### TECHNICAL FIELD

The present invention relates to a heat exchanger and to a Stirling engine including the heat exchanger, and particularly, to a connection structure between a heat exchanging member and an outer shell body (a cylindrical member) constituting a heat exchanger.

### BACKGROUND ART

Conventionally, to a heat exchanger of a refrigerator and the like, a heat exchanging member for conducting heat exchange is attached. For example, Japanese Patent Laying-Open No. 2001-91075 describes a heat exchanger for a Stirling engine, which includes a cylindrical member and a corrugated fin as a heat exchanging member. The corrugated fin is mounted inside the cylindrical member. Here, a ring-like member is used to press the corrugated fin toward the cylindrical member, whereby the corrugated fin is attached with applying pressure to the cylindrical member.

Japanese Patent Laying-Open No. 2003-251459 describes a heat exchanger of a refrigerator wherein a heat exchanging member is attached to the inside of a cylindrical case. In the heat exchanger, a plating layer is formed on at least one of an outer circumferential surface of the heat exchanging member and an inner circumferential surface of the cylindrical case. Eutectic alloy produced from eutectic reaction with the plating layer bonds the cylindrical case and the heat exchanging member at a heat transfer interface therebetween.

Patent Document 1: Japanese Patent Laying-Open No. 2001-091075

Patent Document 2: Japanese Patent Laying-Open No. 2003-251459

### DISCLOSURE OF THE INVENTION

### Problems to be Solved by the Invention

On the other hand, it is difficult to ensure provision of a sufficient contacting area between the corrugated fin and the cylindrical member just by attaching the corrugated fin with applying pressure to the inner circumferential surface as in the heat exchanger of Japanese Patent Laying-Open No. 2001-91075. With the insufficient contacting area between the corrugated fin and the cylindrical member, a problem arises that heat transfer efficiency from the corrugated fin to the cylindrical member is reduced and consequently the performance of the heat exchanger is impaired.

Even when eutectic alloy produced from eutectic reaction with the plating layer bonds the cylindrical case and the heat exchanging member at a heat transfer interface therebetween as in Japanese Patent Laying-Open No. 2003-251459, if the contacting area between the cylindrical case and the plating layer is insufficient at the stage prior to the production of eutectic alloy, consequently the sufficient contacting area is hardly obtained. Accordingly, the problem similar to that in Japanese Patent Laying-Open No. 2001-91075 may arise.

The present invention has been made to solve problems such as described above, and an object thereof is to provide a heat exchanger with which a contacting area between a heat exchanging member and an outer shell body to which the heat exchanging member is attached can be increased, and a Stirling engine including the heat exchanger.

### Means for Solving the Problems

A heat exchanger according to the present invention includes, in one aspect, an outer shell body made of metal, a heat exchanging member that is made of metal and that is attached to a circumferential surface of the outer shell body, and a coating layer formed on at least one of the circumferential surface of the outer shell body and a circumferential surface of the heat exchanging member. The heat exchanging member is pressure-contacted to the outer shell body. In the present specification, a “heat exchanging member” refers to a member that has a function of conducting heat exchange with a working medium or the like. The coating layer may at least partially coat the circumferential surface of the outer shell body and/or the circumferential surface of the heat exchanging member.

Preferably, the coating layer is lower in hardness than at least one of the outer shell body and the heat exchanging member. As to the coating layer, a material other than metal can be employed if it has an excellent heat conductivity. When the coating layer is constituted of a metal material, an alloy layer may be formed between the outer shell body and the heat exchanging member, which is formed by alloying of the metal material constituting the coating layer and a metal material constituting at least one of the outer shell body and the heat exchanging member. The coating layer may be melted and thereafter solidified.

A heat exchanger according to the present invention includes, in the other aspect, an outer shell body made of metal, and a heat exchanging member that is constituted of a copper material containing copper by at least 99.99% or of a copper material containing at least one of silver and tin, and that is attached to the outer shell body. A circumferential surface of the heat exchanging member is pressure-contacted to the circumferential surface of the outer shell body. That is, in the present aspect, a material that is excellent not only in heat conductivity but also in ductility is employed as the material of the heat exchanging member.

The outer shell body may be constituted of a cylindrical member, for example. The heat exchanging member may be constituted of a corrugated fin, for example. Here, the heat exchanging member is attached to the inside of the outer shell body.

A Stirling engine according to the present invention includes the heat exchanger as described above.

### EFFECTS OF THE INVENTION

With the heat exchanger in one aspect of the present invention, the heat exchanging member is pressure-contacted to the outer shell body, and therefore a contacting area between the heat exchanging member and/or outer shell body and the coating layer can be increased as compared to a case where the heat exchanging member and/or the outer shell body simply abuts on the coating layer. The coating layer is formed on at least one of the surface of the outer shell body and the surface of the heat exchanging member, and therefore it implements part of the heat exchanging member and/or the outer shell body. Accordingly, the contacting area between the heat exchanging member and/or the outer shell body and the coating layer increases, and consequently the contacting area between the heat exchanging member and the outer shell body can be increased.

With the heat exchanger in the other aspect of the present invention, as a material of the heat exchanging member, a copper material containing copper by at least 99.99% or a copper material containing at least one of silver and tin is employed. Thus, ductility of the heat exchanging member itself can be improved. This can increase the degree of deformation of the heat exchanging member at the contacting portion between the heat exchanging member and the outer shell body when the heat exchanging member is pressure-contacted to the outer shell body. In this case also, the contacting area between the heat exchanging member and the outer shell body can be increased.

As the Stirling engine of the present invention includes the heat exchanger as described above, such a Stirling engine can be provided that includes the heat exchanger of high performance and where provision of the contacting area between the heat exchanging member and the outer shell body is ensured.

### BRIEF DESCRIPTION OF THE DRAWINGS

FIG. 1 is a cross-sectional perspective view of a substantial part of a heat exchanger of a first embodiment of the present invention.

FIG. 2 is a partial enlarged view of the heat exchanger shown in FIG. 1.

FIG. 3 is a substantial part enlarged view of FIG. 2.

FIG. 4 shows a modification of the structure shown in FIG. 3.

FIG. 5 is a partial enlarged view of a heat exchanger of a second embodiment of the present invention.

FIG. 6 is an enlarged view of a substantial part of FIG. 5.

FIG. 7 shows a modification of the structure shown in FIG. 6.

FIG. 8 is a partial enlarged view of a heat exchanger of a third embodiment of the present invention.

FIG. 9 is a partial enlarged view of a heat exchanger of a fourth embodiment of the present invention.

FIG. 10 is a cross-sectional view of a Stirling engine including the heat exchanger according to the present invention.

### DESCRIPTION OF THE REFERENCE SIGNS

1, 1A, 1B heat exchanger; 2 corrugated fin; 2a outer circumferential portion; 2b inner circumferential portion; 3 ring-like member; 4 cylindrical member; 5 coating layer; 7 Stirling engine; 8 tube; 12 casing; 13 cylinder; 14 piston; 15 displacer; 16 regenerator; 17 working space; 17A compression space; 17B expansion space; 18 heat dissipating portion; 19 heat absorbing portion; 20 inner yoke; 21 movable magnet portion; 22 outer yoke; 23 linear motor; 24 piston spring; 25 displacer spring; 26 displacer rod; and 27 back-pressure space.

### BEST MODES FOR CARRYING OUT THE INVENTION

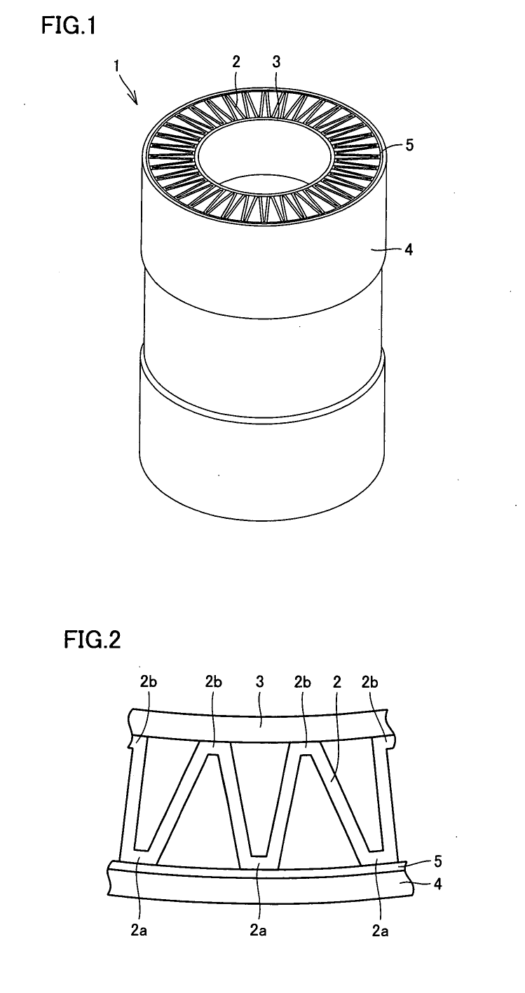

In the following, referring to FIGS. 1-10, embodiments of the present invention will be described.

### First Embodiment

FIG. 1 is a perspective view of a heat exchanger 1 of a first embodiment of the present invention. FIG. 2 is a partial enlarged view of heat exchanger 1 shown in FIG. 1.

The heat exchanger of the first embodiment includes: a cylindrical or bottomed cylindrical outer shell body made of metal; a heat exchanging member that is made of metal and that is attached to an inner circumferential surface of the outer shell body; and a coating layer formed on at least one of the inner circumferential surface of the outer shell body and an outer surface of the heat exchanging member. In the example of FIG. 1, heat exchanger 1 includes: a cylindrical or bottomed cylindrical member 4 made of metal as the outer shell body (a member implementing a heat dissipating portion or a heat absorbing portion: hereinafter referred to as a cylindrical member); a corrugated fin 2 that is made of metal and that is attached to cylindrical member 4 as the heat exchanging member; and a ring-like member 3 made of metal.

Cylindrical member 4 can be constituted of a metal material (including alloy) with an excellent heat conductivity, for example, copper (Cu), copper alloy, stainless steel, aluminum (Al), aluminum alloy and the like, or a composite material of a combination of such materials.

In the example of FIG. 1, inside cylindrical member 4, corrugated fin 2 is attached. Corrugated fin 2 is a member carrying out heat exchange with a working medium, with its outer diameter being designed to be substantially the same as the inner diameter of cylindrical member 4. Thus, by applying force to the inner circumferential of corrugated fin 2 with force in the externally radial direction of cylindrical member 4, the outer circumferential surface of corrugated fin 2 can be pressed against the inner circumferential surface of cylindrical member 4 and the outer circumferential surface of the corrugated fin 2 can be pressure-contacted to the inner circumferential surface of cylindrical member 4. Corrugated fin 2 can be manufactured from copper or copper alloy, for example.

Ring-like member 3 mainly has a function of pressing corrugated fin 2 against the inner circumferential surface of cylindrical member 4 to fix the same. Ring-like member 3 may be constituted of the same material as cylindrical member 4, or of a different material therefrom. For example, ring-like member 3 may be constituted of a material that is higher in hardness than a material of corrugated fin 2.

Ring-like member 3 typically has the outer diameter slightly greater than the inner diameter of corrugated fin 2, and pressed in inside corrugated fin 2 after corrugated fin 2 is attached to the inside of cylindrical member 4. Here, constituting ring-like member 3 of the material higher in hardness than the material of corrugated fin 2, the degree of deformation of ring-like member 3 when pressed in can be reduced, and corrugated fin 2 can surely and effectively be provided with the force in the externally radial direction of cylindrical member 4.

In the first embodiment, as shown in FIG. 2, coating layer 5 is formed on the inner circumferential surface of cylindrical member 4. As shown in FIG. 2, corrugated fin 2 has an outer circumferential portion 2a, an inner circumferential portion 2b, and a connecting portion connecting outer circumferential portion 2a and inner circumferential portion 2b and extending in the radial direction of cylindrical member 4. Corrugated fin 2 is shaped to be regularly concave and convex in its circumferential direction. Outer circumferential portion 2a of corrugated fin 2 is pressure-contacted to coating layer 5 on the inner circumferential surface of cylindrical member 4, while inner circumferential portion 2b of corrugated fin 2 is pressure-contacted to the outer circumferential surface of ring-like member 3.

While coating layer 5 is typically constituted of metal, a material other than metal can be used. When coating layer 5 is to be constituted of metal, it can be formed by a scheme such as plating or deposition. For example, gold (Au) that is excellent in ductility and heat conductivity may be used as coating layer 5. While coating layer 5 may typically be formed in about some μm thickness on the entire inner circumferential surface of cylindrical member 4, it can selectively be formed only at the necessary position. Coating layer 5 may be constituted of a single layer structure or a stacked structure of a plurality of layers. When coating layer 5 is constituted of a stacked structure of a plurality of layers, each layer may be the same or different in material, hardness, thickness and the like.

The important feature of the first embodiment is that the heat exchanging member is attached to the outer shell body so that the coating layer is deformed. In the example shown in FIGS. 1 and 2, corrugated fin 2 is attached to the inside of cylindrical member 4 so that coating layer 5 is deformed. For example, corrugated fin 2 may be pressed in inside cylindrical member 4 to thereby deform coating layer 5. After inserting corrugated fin 2 into cylindrical member 4, pressing corrugated fin 2 toward cylindrical member 4 by ring-like member 3 or the like, coating layer 5 can be deformed by outer circumferential portion 2a of corrugated fin 2.

Since corrugated fin 2 is attached with applying force pressure to cylindrical member 4 so that coating layer 5 is deformed as described above, it becomes possible to attach corrugated fin 2 to cylindrical member 4 with deformed coating layer 5 interposed therebetween, and also coating layer 5 can be arranged around the contacting portion between corrugated fin 2 and cylindrical member 4. In either manners, the contacting area between corrugated fin 2 and coating layer 5 can be increased as compared to a manner where a corrugated fin 2 is simply abutted on coating layer 5. Not only that, by compression and deformation of coating layer 5, a small gap between coating layer 5 and corrugated fin 2 and/or cylindrical member 4 can be reduced. This can also contribute to an increase in the contacting area between corrugated fin 2 and cylindrical member 4.

Advantageously, coating layer 5 may set to be lower in hardness than at least one of corrugated fin 2 and cylindrical member 4, preferably than corrugated fin 2. Thus, not only coating layer 5 can easily be deformed but also the contacting area between corrugated fin 2 and coating layer 5 can further be increased.

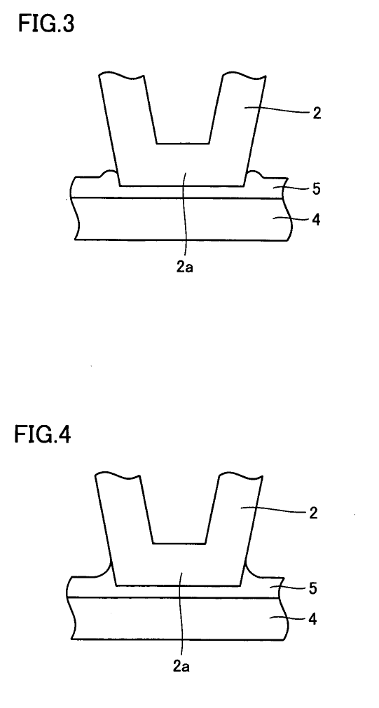

FIG. 3 is an enlarged view of a joining portion (abutting portion) between outer circumferential portion 2a of corrugated fin 2 and the inner circumferential portion of cylindrical member 4 in FIG. 2.

In the example shown in FIG. 3, by pressing outer circumferential portion 2a of corrugated fin 2 against coating layer 5, coating layer 5 is deformed. Correspondingly, a bump of coating layer 5 is formed around outer circumferential portion 2a of corrugated fin 2. Thus, by pressing outer circumferential portion 2a of corrugated fin 2 into coating layer 5, coating layer 5 can be extended on a sidewall of outer circumferential portion 2a of corrugated fin 2, and the contacting area between corrugated fin 2 and coating layer 5 can be increased. Not only that, since coating layer 5 is compressed and deformed between corrugated fin 2 and cylindrical member 4, it becomes possible to allow coating layer 5 to enter a small gap that possibly exists near the surface of outer circumferential portion 2a of corrugated fin 2 or near the inner circumferential surface of cylindrical member 4. This can also effectively contribute to an increase in the contacting area between corrugated fin 2 and cylindrical member 4.

FIG. 4 is a modification of the first embodiment. In the example shown in FIG. 4, coating layer 5 in the state of FIG. 3 is heated and melted, and thereafter solidified. Thus, by melting coating layer 5, in addition to a further increase in the contacting area between corrugated fin 2 and coating layer 5, a further reduction in the aforementioned small gap that possibly exists between outer circumferential portion 2a of corrugated fin 2 and cylindrical member 4 can be attained. By selecting a material having excellent wettablilty to corrugated fin 2 as a material of coating layer 5, coating layer 5 near corrugated fin 2 can be adhered to the surface of corrugated fin 2 when melted, and the contacting area can further be increased.

By appropriately adjusting the temperature in the heating process to coating layer 5, when coating layer 5 is melted, the metal material constituting coating layer 5 and the material constituting at least one of corrugated fin 2 and cylindrical member 4 can be alloyed to form an alloy layer. For example, when at least one of corrugated fin 2 and cylindrical member 4 is constituted of a copper material and coating layer 5 is constituted of a Cu—Sn—Ag (Bi) layer or Cu—Sn—Ag (In) layer of about 10 μm thickness, an alloy layer can be formed between corrugated fin 2 and cylindrical member 4. Here, the effect similar to that described above can be expected.

It is noted that, as the material of coating layer 5, a solder material (Sn—Ag base solder material, a lead-free solder material and the like) in addition to the materials noted above can be used. By causing coating layer 5 to include bismuth (Bi) as an impurity, the alloying temperature can be reduced to about 220° C.

### Second Embodiment

Next, referring to FIGS. 5-7, a second embodiment of the present invention will be described.

In the second embodiment, the coating layer is formed on the heat exchanging member side. Specifically, above-described coating layer 5 is formed on the surface of corrugated fin 2 as shown in FIG. 5. The rest of the configuration is basically the same as in the first embodiment. The effect similar to that in the first embodiment can also be expected in the second embodiment.

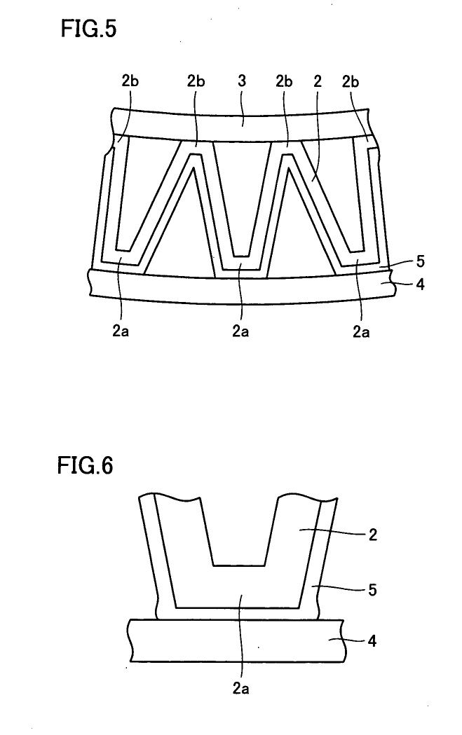

FIG. 6 shows an enlarged view of the joining portion (abutting portion) of outer circumferential portion 2a of corrugated fin 2 and the inner circumferential portion of cylindrical member 4 in FIG. 5.

As shown in FIG. 6, in the second embodiment, by corrugated fin 2 being pressed toward cylindrical member 4, coating layer 5 positioned between corrugated fin 2 and cylindrical member 4 deforms and extends laterally along the surface of cylindrical member 4. Additionally, as coating layer 5 is compressed and deformed, the aforementioned small gap between corrugated fin 2 and cylindrical member 4 can be reduced. Accordingly, as in the first embodiment, the contacting area between corrugated fin 2 and cylindrical member 4 can be increased.

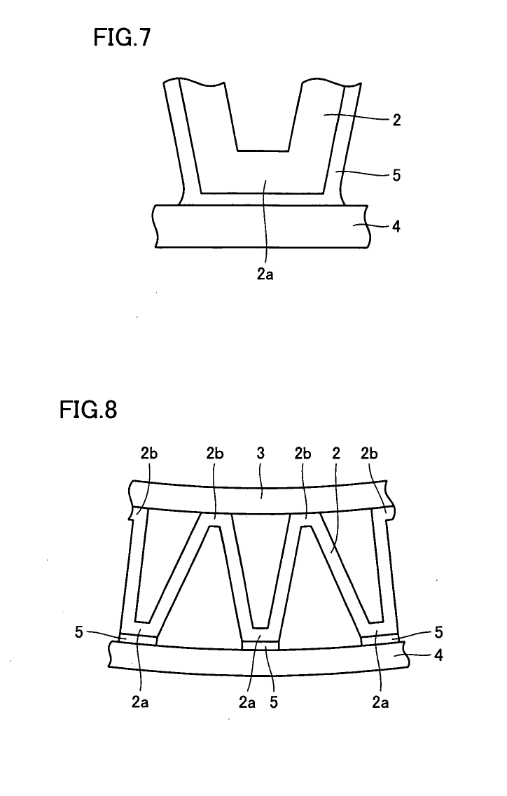

FIG. 7 shows a modification of the second embodiment. As shown in FIG. 7, similarly to the first embodiment, coating layer 5 in the state shown in FIG. 6 may be heated and melted, and thereafter solidified. In the present modification also, by selecting a material having excellent wettablilty to cylindrical member 4 as a material of coating layer 5, when coating layer 5 is melted, coating layer 5 near cylindrical member 4 can be adhered to the surface of cylindrical member 4. This can ensure provision of a contacting area equal to or greater than that in the example of FIG. 6. Additionally, by melting coating layer 5, the aforementioned small gap between outer circumferential portion 2a of corrugated fin 2 and cylindrical member 4 can further be reduced.

Further, similarly to the first embodiment, an alloy layer may be formed, which is formed by alloying of the metal material constituting coating layer 5 and the material constituting at least one of corrugated fin 2 and cylindrical member 4 when coating layer 5 is melted. The specific material for each element may be the same as in the first embodiment. Coating layer 5 of a single layer or a plurality of layers may be formed on the surface of both of outer circumferential portion 2a of corrugated fin 2 and cylindrical member 4.

### Third Embodiment

Next, referring to FIG. 8, a third embodiment of the present invention will be described. In the third embodiment, the coating layer is selectively formed on at least one of the surface of the outer shell body and the surface of the heat exchanging member. Specifically, the coating layer is selectively formed at and near the joining portion of the outer shell body and the heat exchanging member.

In the example of FIG. 8, coating layer 5 is formed only between outer circumferential portion 2a of corrugated fin 2 and cylindrical member 4. Coating layer 5 may be formed to at least one of corrugated fin 2 and cylindrical member 4. For selectively forming coating layer 5 only on the surface of outer circumferential portion 2a of corrugated fin 2, for example only outer circumferential portion 2a of corrugated fin 2 may be dipped in a plating solution. For selectively forming coating layer 5 on an inner circumferential surface of cylindrical member 4, for example a mask may selectively be formed on the inner circumferential surface of cylindrical member 4 and a coating layer 5 may be formed by deposition or the like on the inner circumferential surface of cylindrical member 4 where the mask is not formed.

In the third embodiment also, by deforming coating layer 5, the contacting area between corrugated fin 2 and/or cylindrical member 4 and coating layer 5 can be increased, while a small gap between corrugated fin 2 and cylindrical member 4 can be reduced.

Additionally, as in the above-described first and second embodiments, coating layer 5 may be deformed and melted, and thereafter solidified. Here, the effect similar to that in the first and second embodiments can be expected.

### Fourth Embodiment

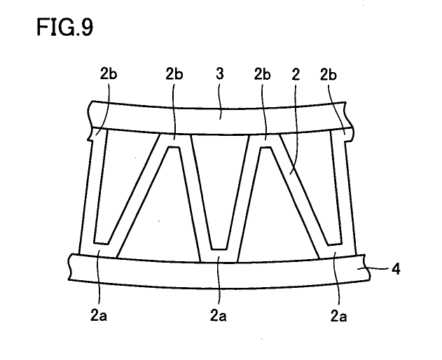

Next, referring to FIG. 9, a fourth embodiment of the present invention will be described. While in each of the above-described embodiment the coating layer is formed between the outer shell body and the heat exchanging member, in the fourth embodiment the ductility of the heat exchanging member itself is improved without forming such a coating layer.

FIG. 9 is a partial enlarged view of a heat exchanger 1 of the fourth embodiment of the present invention. As shown in FIG. 9, in the fourth embodiment, a coating layer is not formed between outer circumferential portion 2a of corrugated fin 2 and cylindrical member 4, and outer circumferential portion 2a of corrugated fin 2 and cylindrical member 4 directly contact to each other.

Then, the ductility of corrugated fin 2 itself is improved. For improving the ductility of corrugated fin 2, in one example, if corrugated fin 2 is constituted of substantially one material, improvement of the ductility of corrugated fin 2 may be attained by increasing the purity of the material. In another example, addition of another material to the material mainly constituting corrugated fin 2 may improve the ductility.

For example, when corrugated fin 2 is constituted of copper, by producing corrugated fin 2 using a copper material containing copper by at least 99.99%, the ductility of corrugated fin 2 itself can be improved. When corrugated fin 2 is constituted of a material including copper and a metal material other than copper, corrugated fin 2 may be constituted of a copper material (i.e., the material containing copper as the main component) containing materials other than copper such as silver or tin. In this example also, by adding the material such as silver or tin to the main component of copper, the ductility of the copper material can be improved.

By improving the ductility of the corrugated fin 2 itself as above, corrugated fin 2 can easily be deformed when it is attached to cylindrical member 4. Thus, corrugated fin 2 can be deformed so as to conform to the inner circumferential surface of cylindrical member 4 at positions where corrugated fin 2 is pressure-contacted to the inner circumferential surface of cylindrical member 4, whereby the contacting area between corrugated fin 2 and cylindrical member 4 can be increased.

While in each of the above-described embodiments examples where the heat exchanging member made of metal is attached to the inside of the outer shell body made of metal have been described, the idea of the present invention is also applicable to an example where a heat exchanging member made of metal is attached to the outside of the outer shell body made of metal.

### Fifth Embodiment

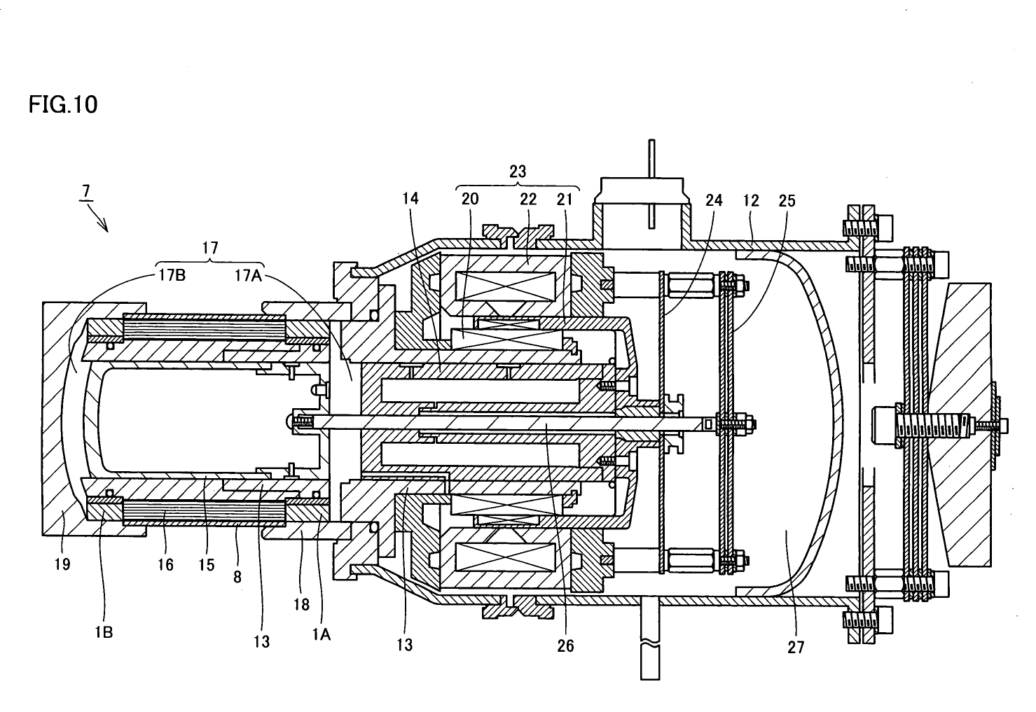

Next, referring to FIG. 10, a fifth embodiment of the present invention will be described. In the fifth embodiment, the heat exchanger according to the above-described embodiments is incorporated into a Stirling engine.

Now, referring to FIG. 10, the structure of the Stirling engine of the fifth embodiment is described. As shown in FIG. 10, a Stirling engine 7 includes a casing 12, a cylinder 13 attached to casing 12, a piston 14 and a displacer 15 reciprocating inside cylinder 13, a regenerator 16, a working space 17 including a compression space 17A and an expansion space 17B, a heat dissipating portion 18 (warm head), a heat absorbing portion 19 (cold head), a linear motor 23 as piston driving means, a piston spring 24, a displacer spring 25, a displacer rod 26 and a back-pressure space 27.

Various components such as cylinder 13, linear motor 23, piston spring 24, and displacer spring 25 are attached to casing 12. Stirling engine 7 is filled with a working medium such as helium gas, hydrogen gas, nitride gas or the like.

Cylinder 13 has a substantially cylindrical shape, and internally receives piston 14 and displacer 15 so that they can reciprocate. In cylinder 13, piston 14 and displacer 15 are arranged coaxially with a distance from each other, and divide working space 17 into compression space 17A and expansion space 17B. More specifically, working space 17 positions on displacer 15 side relative to the end surface of piston 14 facing displacer 15. Compression space 17A is formed between piston 14 and displacer 15, and expansion space 17B is formed between displacer 15 and heat absorbing portion 19. Compression space 17A is enclosed mainly by heat dissipating portion 18, and expansion space 17B is enclosed mainly by heat absorbing portion 19.

Between compression space 17A and expansion space 17B, regenerator 16, wherein a film is wound with prescribed intervals on the inner circumferential surface of tube 8, is arranged, through which compression space 17A and expansion space 17B communicate. This forms a closed circuit in Stirling engine 7. The working medium enclosed in the closed circuit flows in accordance with the operation of piston 14 and displacer 15, whereby the reverse Stirling cycle is realized.

Linear motor 23 is arranged in back-pressure space 27 positioned outside cylinder 13. Linear motor 23 has an inner yoke 20, a movable magnet portion 21, and an outer yoke 22. Linear motor 23 drives piston 14 in the axial direction of cylinder 13.

Piston 14 has its one end connected to piston spring 24 that is constituted of a leaf spring or the like. Piston spring 24 functions as elastic force providing means for providing elastic force to piston 14. By providing the elastic force by piston spring 24 piston 14 is allowed to cyclically reciprocate in cylinder 13 stably. Displacer 15 has its one end connected to displacer spring 25 with displacer rod 26 interposed therebetween. Displacer rod 26 is arranged to penetrate through piston 14. Displacer spring 25 is constituted of a leaf spring or the like. The peripheral portion of displacer spring 25 and the peripheral portion of piston spring 24 are supported by a supporting member extending from linear motor 23 toward back-pressure space 27.

Back-pressure space 27 enclosed by casing 12 is arranged opposite to displacer 15 relative to piston 14. Back-pressure space 27 includes an outer circumferential region positioned around piston 14 in casing 12 and a rear region positioned closer to piston spring 24 side than to piston 14 in casing 12 (rear side). Inside back-pressure space 27 also, the working medium exists.

Heat dissipating portion 18 and heat absorbing portion 19 are provided with a heat exchanger 1A (a high-temperature side heat exchanger) and a heat exchanger 1B (a low-temperature side heat exchanger), respectively. As heat exchangers 1A and 1B, the heat exchangers described in the embodiments are used. That is, on the inner circumferential surface of heat dissipating portion 18 and heat absorbing portion 19, the outer circumferential surface of corrugated fin 2 is connected (joined) by the schemes described in the embodiments.

Thus, the contacting area between heat dissipating portion 18, heat absorbing portion 19 and corrugated fin 2 can be increased. That is, a sufficient contacting area between the heat exchanging member and the outer shell body in the heat exchanger can be provided. Accordingly, the heat resistance in the heat exchanger can be reduced, and heat transfer loss can be reduced. As a result, a Stirling engine with a heat exchanger of high performance where heat resistance is reduced can be obtained. When it is used for a refrigerator for example, the refrigeration capacity can be improved.

Next, an operation of the above-described Stirling engine 7 is described.

First, linear motor 23 is actuated to drive piston 14. Piston 14 driven by linear motor 23 approaches displacer 15 and compresses the working medium (working gas) in compression space 17A.

Piston 14 approaches displacer 15, whereby the temperature of the working medium in compression space 17A is increased. The heat is transferred via heat exchanger 1A to heat dissipating portion 18, which in turn dissipates heat generated inside compression space 17A to the outside. Thus, the temperature of the working medium inside compression space 17A is maintained substantially isothermal. That is, this process corresponds to the isothermal compression process in the reverse Stirling cycle.

After piston approaches displacer 15, displacer 15 moves toward heat absorbing portion 19 side. On the other hand, the working medium compressed in compression space 17A by piston 14 flows into regenerator 16, and further into expansion space 17B. Here, the heat of working medium is stored in regenerator 16. That is, this process corresponds to the isovolumic cooling process of the reverse Stirling cycle.

The working medium of high pressure flown into expansion space 17B expands as displacer 15 moves toward piston 14 side (the side of the rear end of a vessel portion of casing 12). Thus, as displacer 15 moves toward the rear side, a center portion of displacer spring 25 also deforms so as to project toward the rear side.

As described above, by the expansion of the working medium in expansion space 17B, the temperature of the working medium in expansion space 17B is reduced. On the other hand, the outside heat is transferred to expansion space 17B by heat absorbing portion 19, and therefore expansion space 17 is maintained to be substantially isothermal. That is, this process corresponds to the isothermal expansion process in the reverse Stirling cycle.

Thereafter, displacer 15 starts to move in the direction away from piston 14, whereby the working medium in expansion space 17B passes through regenerator 16 and returns again to compression space 17A side. Here, the heat having been stored in regenerator 16 is provided to working medium, whereby the temperature of the working medium is increased. That is, this process corresponds to the isovolumic heating process of the reverse Stirling cycle.

The series of processes (isothermal compression process—isovolumic cooling process—isothermal expansion process—isovolumic heating process) is repeated to constitute the reverse Stirling cycle. As a result, the temperature of heat absorbing portion 19 gradually decreases to reach cryogenic temperature. On the other hand, the temperature of heat dissipating portion 18 gradually increases to reach a prescribed high temperature. Here, by employing heat exchangers 1A and 1B of the present embodiment, heat from the working medium can efficiently be transferred to heat absorbing portion 19 and heat dissipating portion 18 via heat exchangers 1A and 1B.

In the foregoing, the embodiments of the present invention have been described. Combinations of the embodiments are also originally intended.

It should be understood that the embodiments disclosed herein are illustrative and non-restrictive in every respect. The scope of the present invention is defined by the terms of the claims, and includes any modifications and changes within the scope and meaning equivalent to the terms of the claims.

### INDUSTRIAL APPLICABILITY

The present invention is effectively applicable to a heat exchanger and to a Stirling engine including the heat exchanger.

1-7. (canceled)

8. A heat exchanger, comprising:
a cylindrical or bottomed cylindrical outer shell body made of metal;
a heat exchanging member that is made of metal and that is attached to a circumferential surface of said outer shell body; and
a coating layer formed with a metal material on at least one of the circumferential surface of said outer shell body and a circumferential surface of said heat exchanging member, wherein
said coating layer is lower in hardness than said heat exchanging member, and
said heat exchanging member is pressure-contacted to said outer shell body.

9. A Stirling engine comprising the heat exchanger according to claim 8.

10. A heat exchanger, comprising:
a cylindrical or bottomed cylindrical outer shell body made of metal;
a heat exchanging member that is made of metal and that is attached to a circumferential surface of said outer shell body; and
a coating layer formed on at least one of the circumferential surface of said outer shell body and a circumferential surface of said heat exchanging member, wherein
said heat exchanging member is pressure-contacted to said outer shell body, and
said coating layer is constituted of a metal material, said heat exchanger further comprising
an alloy layer between said outer shell body and said heat exchanging member, said alloy layer being formed by alloying of said metal material constituting said coating layer and a metal material constituting at least one of said outer shell body and said heat exchanging member.

11. A Stirling engine comprising the heat exchanger according to claim 10.
